(19) United States
(12) Patent Application Publication
(10) Pub. No.: US 2026/0067499 A1
(43) Pub. Date: Mar. 5, 2026

(54) BASE-MESH HANDLE CODING

(71) Applicant: Samsung Electronics Co., Ltd., Suwon-si (KR)

(72) Inventors: Madhukar Budagavi, Plano, TX (US); Rajan Laxman Joshi, San Diego, CA (US)

(21) Appl. No.: 19/303,249

(22) Filed: Aug. 18, 2025

Related U.S. Application Data
(60) Provisional application No. 63/687,521, filed on Aug. 27, 2024.
(60) Provisional application No. 63/713,998, filed on Oct. 30, 2024.
(60) Provisional application No. 63/715,787, filed on Nov. 4, 2024.

(51) Int. Cl. H04N 19/597; H04N 19/91

(52) U.S. Cl. CPC H04N 19/597; H04N 19/91

(57) ABSTRACT

An apparatus includes a communication interface configured to receive a compressed bitstream comprising a base mesh sub-bitstream including mesh handle information and a processor operably coupled to the communication interface. The processor is configured to modify at least one coded value to reduce an amount of unused codewords. The at least one coded value is modified based on adding an offset to a fixed length decoded value to generate a final decoded value. The processor is also configured to reconstruct a base mesh using the final decoded value.

### CROSS-REFERENCE TO RELATED APPLICATION AND PRIORITY CLAIM

This application claims priority under 35 U.S.C. § 119(e) to U.S. Provisional Patent Application No. 63/687,521 filed on Aug. 27, 2024, U.S. Provisional Patent Application No. 63/713,998 filed on Oct. 30, 2024, and U.S. Provisional Patent Application No. 63/715,787 filed on Nov. 4, 2024, which are hereby incorporated by reference in their entirety.

### TECHNICAL FIELD

This disclosure relates generally to multimedia devices and processes. More specifically, this disclosure relates to base-mesh handle coding.

### BACKGROUND

Three hundred sixty degree (360°) video and three dimensional (3D) volumetric video are emerging as new ways of experiencing immersive content due to the ready availability of powerful handheld devices such as smartphones. While 360° video enables an immersive “real life,” “being-there,” experience for consumers by capturing the 360° outside-in view of the world, 3D volumetric video can provide a complete six degrees of freedom (DoF) experience of being immersed and moving within the content. Users can interactively change their viewpoint and dynamically view any part of the captured scene or object they desire. Display and navigation sensors can track head movement of a user in real-time to determine the region of the 360° video or volumetric content that the user wants to view or interact with. Multimedia data that is 3D in nature, such as point clouds or 3D polygonal meshes, can be used in the immersive environment. This data can be stored in a video format and encoded and compressed for transmission as a bitstream to other devices.

### SUMMARY

This disclosure provides for base-mesh handle coding.

In one embodiment, an apparatus includes a communication interface configured to receive a compressed bitstream comprising a base mesh sub-bitstream including mesh handle information and a processor operably coupled to the communication interface. The processor is configured to modify at least one coded value to reduce an amount of unused codewords. The at least one coded value is modified based on adding an offset to a fixed length decoded value to generate a final decoded value. The processor is also configured to reconstruct a base mesh using the final decoded value.

In another embodiment, a method includes receiving a compressed bitstream comprising a base mesh sub-bitstream including mesh handle information. The method also includes modifying at least one coded value to reduce an amount of unused codewords. The at least one coded value is modified based on adding an offset to a fixed length decoded value to generate a final decoded value. The method also includes reconstructing a base mesh using the final decoded value.

In yet another embodiment, an apparatus includes a communication interface and a processor operably coupled to the communication interface. The processor is configured to obtain a value associated with a mesh handle of a base mesh. The processor is also configured to subtract an offset from the value to generate a coded value. The processor is also configured to create a compressed bitstream comprising mesh handle information including the coded value.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with this disclosure;

FIGS. 2 and 3 illustrate example electronic devices in accordance with this disclosure;

FIG. 4 illustrates an example encoding process in accordance with this disclosure;

FIG. 5 illustrates an example mesh frame decoding process in accordance with this disclosure;

FIGS. 6A-6C illustrate example meshes in accordance with this disclosure;

FIG. 7 illustrates example binarization coding information;

FIG. 8 illustrates example binarization coding information in accordance with this disclosure;

FIG. 9 illustrates example binarization coding information where groups of 3 bits are used to represent the mesh handle information, but no offset is used;

FIG. 10 illustrates example binarization coding information using groups of 3 bits, and using an offset, in accordance with this disclosure;

FIG. 11 illustrates example binarization coding information using a maximum number of offsets, in accordance with this disclosure;

FIG. 12 illustrates an example encoding method in accordance with this disclosure; and

FIG. 13 illustrates an example decoding method in accordance with this disclosure.

### DETAILED DESCRIPTION

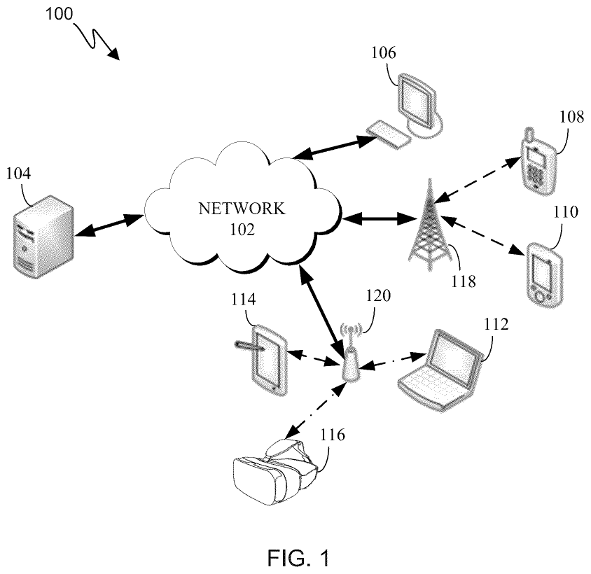

FIGS. 1 through 13, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

As noted above, three hundred sixty degree (360°) video and three dimensional (3D) volumetric video are emerging as new ways of experiencing immersive content due to the ready availability of powerful handheld devices such as smartphones. While 360° video enables an immersive “real life,” “being-there,” experience for consumers by capturing the 360° outside-in view of the world, 3D volumetric video can provide a complete six degrees of freedom (DoF) experience of being immersed and moving within the content. Users can interactively change their viewpoint and dynamically view any part of the captured scene or object they desire. Display and navigation sensors can track head movement of a user in real-time to determine the region of the 360° video or volumetric content that the user wants to view or interact with. Multimedia data that is 3D in nature, such as point clouds or 3D polygonal meshes, can be used in the immersive environment. This data can be stored in a video format and encoded and compressed for transmission as a bitstream to other devices.

A point cloud is a set of 3D points along with attributes such as color, normal directions, reflectivity, point-size, etc. that represent an object's surface or volume. Point clouds are common in a variety of applications such as gaming, 3D maps, visualizations, medical applications, augmented reality, virtual reality, autonomous driving, multi-view replay, and six degrees of freedom (DoF) immersive media, to name a few. Point clouds, if uncompressed, generally require a large amount of bandwidth for transmission. Due to the large bitrate requirement, point clouds are often compressed prior to transmission. Compressing a 3D object such as a point cloud, often requires specialized hardware. To avoid specialized hardware to compress a 3D point cloud, a 3D point cloud can be transformed into traditional two-dimensional (2D) frames and that can be compressed and later reconstructed and viewable to a user.

Polygonal 3D meshes, especially triangular meshes, are another popular format for representing 3D objects. Meshes typically include a set of vertices, edges and faces that are used for representing the surface of 3D objects. Triangular meshes are simple polygonal meshes in which the faces are simple triangles covering the surface of the 3D object. Typically, there may be one or more attributes associated with the mesh. In one scenario, one or more attributes may be associated with each vertex in the mesh. For example, a texture attribute (RGB) may be associated with each vertex. In another scenario, each vertex may be associated with a pair of coordinates, (u, v). The (u, v) coordinates may point to a position in a texture map associated with the mesh. For example, the (u, v) coordinates may refer to row and column indices in the texture map, respectively. A mesh can be thought of as a point cloud with additional connectivity information.

The point cloud or meshes may be dynamic, i.e., they may vary with time. In these cases, the point cloud or mesh at a particular time instant may be referred to as a point cloud frame or a mesh frame, respectively. Since point clouds and meshes contain a large amount of data, they require compression for efficient storage and transmission. This is particularly true for dynamic point clouds and meshes, which may contain 60 frames or higher per second.

As part of an encoding process, a base mesh can be coded using an existing mesh codec, and a reconstructed base mesh can be constructed from the coded original mesh. The reconstructed base mesh can then be subdivided into one or more subdivided meshes and a displacement field is created for each subdivided mesh.

This disclosure provides for improvements to base mesh handle coding. As noted above, a base mesh, which is a decimated version of an original mesh to minimize the amount of compressed data, is created. In some instance in this disclosure, the term “submesh” can refers to the partitioning of the base mesh. A standard for video-based compression of dynamic meshes is currently in development. A base mesh, which typically has less number of vertices compared to the original mesh, is created and compressed either in a lossy or lossless manner. The reconstructed base mesh undergoes subdivision and then a displacement field between the original mesh and the subdivided reconstructed base mesh is calculated. This disclosure relates to improvements to the coding of handle information in the base-mesh.

FIG. 1 illustrates an example communication system 100 in accordance with this disclosure. The embodiment of the communication system 100 shown in FIG. 1 is for illustration only. Other embodiments of the communication system 100 can be used without departing from the scope of this disclosure.

As shown in FIG. 1, the communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a TV, an interactive display, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. As described in more detail below, the server 104 can transmit a compressed bitstream, representing a point cloud or mesh, to one or more display devices, such as a client device 106-116. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. The HMD 116 can display 360° scenes including one or more dynamic or static 3D point clouds or mesh. In certain embodiments, any of the client devices 106-116 can include an encoder, decoder, or both. For example, the mobile device 108 can record a 3D volumetric video and then encode the video enabling the video to be transmitted to one of the client devices 106-116. In another example, the laptop computer 112 can be used to generate a 3D point cloud or mesh, which is then encoded and transmitted to one of the client devices 106-116.

In this example, some client devices 108-116 communicate indirectly with the network 102. For example, the mobile device 108 and PDA 110 communicate via one or more base stations 118, such as cellular base stations or eNodeBs (eNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s). In certain embodiments, the server 104 or any client device 106-116 can be used to compress a point cloud or mesh, generate a bitstream that represents the point cloud or mesh, and transmit the bitstream to another client device such as any client device 106-116.

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

In certain embodiments, any of the client devices 106-116 or the server 104 can create a 3D point cloud or mesh, compress a 3D point cloud or mesh, transmit a 3D point cloud or mesh, receive a 3D point cloud or mesh, decode a 3D point cloud or mesh, render a 3D point cloud or mesh, or a combination thereof. For example, the server 104 can compress a 3D point cloud or mesh to generate a bitstream and then transmit the bitstream to one or more of the client devices 106-116. As another example, one of the client devices 106-116 can compress a 3D point cloud or mesh to generate a bitstream and then transmit the bitstream to another one of the client devices 106-116 or to the server 104. In accordance with this disclosure, the server 104 and/or the client devices 106-116 can use a number of vertices of the original mesh and/or distortion information for each reconstruction iteration to simplify submeshes. Additionally or alternatively, in accordance with this disclosure, the server 104 and/or the client devices 106-116 can use a copy of a decimated mesh for reconstructing one or more submeshes. In some embodiments, the server 104 and/or the client devices 106-116 can construct and transmit signaling information instructing another device to use a number of vertices of the original mesh and/or distortion information for each reconstruction iteration to simplify submeshes and/or create and use a copy of a decimated mesh for reconstructing one or more submeshes.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

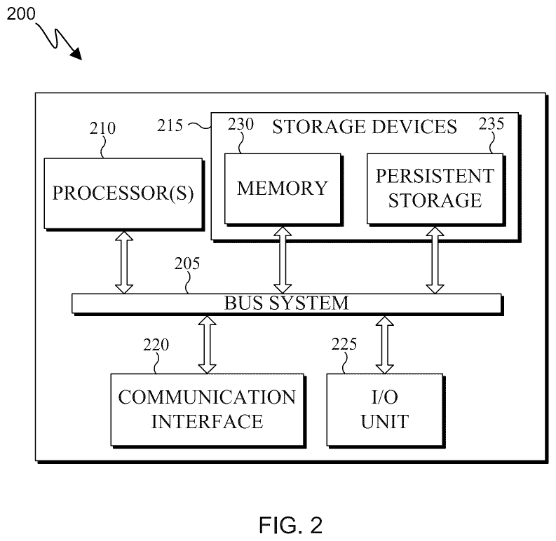

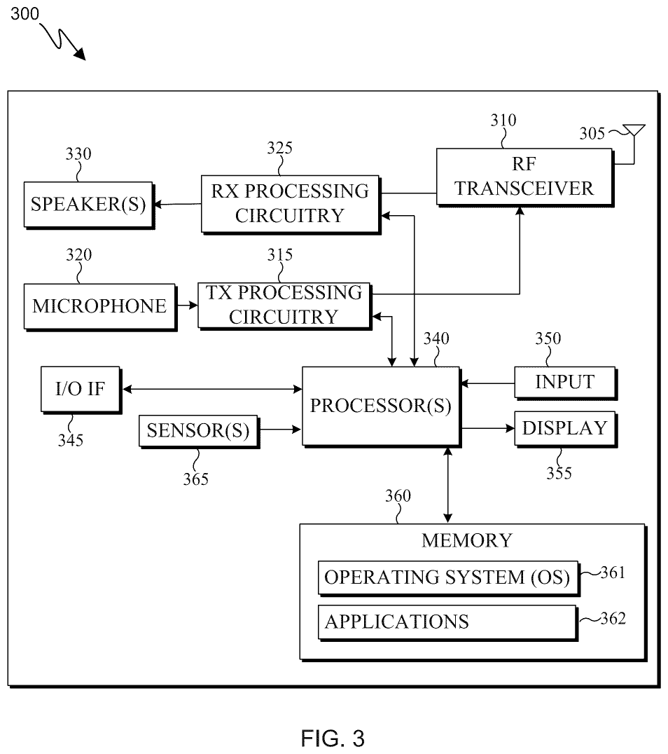

FIGS. 2 and 3 illustrate example electronic devices in accordance with this disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 can represent one or more local servers, one or more compression servers, or one or more encoding servers, such as an encoder. In certain embodiments, the encoder can perform decoding. As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

In certain embodiments, the processor 210 can encode a 3D point cloud or mesh stored within the storage devices 215. In certain embodiments, encoding a 3D point cloud also decodes the 3D point cloud or mesh to ensure that when the point cloud or mesh is reconstructed, the reconstructed 3D point cloud or mesh matches the 3D point cloud or mesh prior to the encoding. In certain embodiments, the processor 210 can use a number of vertices of the original mesh and/or distortion information for each reconstruction iteration to simplify submeshes. Additionally or alternatively, the processor 210 can create and use a copy of a decimated mesh for reconstructing one or more submeshes as described in this disclosure. In some embodiments, the processor 210 can construct and transmit signaling information instructing another device to use a number of vertices of the original mesh and/or distortion information for each reconstruction iteration to simplify submeshes and/or create and use a copy of a decimated mesh for reconstructing one or more submeshes.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). For example, the instructions stored in the memory 230 can include instructions for decomposing a point cloud into patches, instructions for packing the patches on 2D frames, instructions for compressing the 2D frames, as well as instructions for encoding 2D frames in a certain order in order to generate a bitstream. The instructions stored in the memory 230 can also include instructions for rendering the point cloud or mesh on an omnidirectional 360° scene, as viewed through a VR headset, such as HMD 116 of FIG. 1. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

In certain embodiments, the processor 340 can use a number of vertices of the original mesh and/or distortion information for each reconstruction iteration to simplify submeshes. Additionally or alternatively, the processor 340 can create and use a copy of a decimated mesh for reconstructing one or more submeshes as described in this disclosure. In some embodiments, the processor 340 can construct and transmit signaling information instructing another device to use a number of vertices of the original mesh and/or distortion information for each reconstruction iteration to simplify submeshes and/or create and use a copy of a decimated mesh for reconstructing one or more submeshes.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within an HMD. The display 355 can be a singular display screen or multiple display screens capable of creating a stereoscopic display. In certain embodiments, the display 355 is a heads-up display (HUD). The display 355 can display 3D objects, such as a 3D point cloud or mesh.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, meshes, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

As discussed in greater detail below, one or more of these sensor(s) 365 may be used to control a user interface (UI), detect UI inputs, determine the orientation and facing the direction of the user for three-dimensional content display identification, and the like. Any of these sensor(s) 365 may be located within the electronic device 300, within a secondary device operably connected to the electronic device 300, within a headset configured to hold the electronic device 300, or in a singular device where the electronic device 300 includes a headset.

The electronic device 300 can create media content such as generate a virtual object or capture (or record) content through a camera. The electronic device 300 can encode the media content to generate a bitstream, such that the bitstream can be transmitted directly to another electronic device or indirectly such as through the network 102 of FIG. 1. The electronic device 300 can receive a bitstream directly from another electronic device or indirectly such as through the network 102 of FIG. 1.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

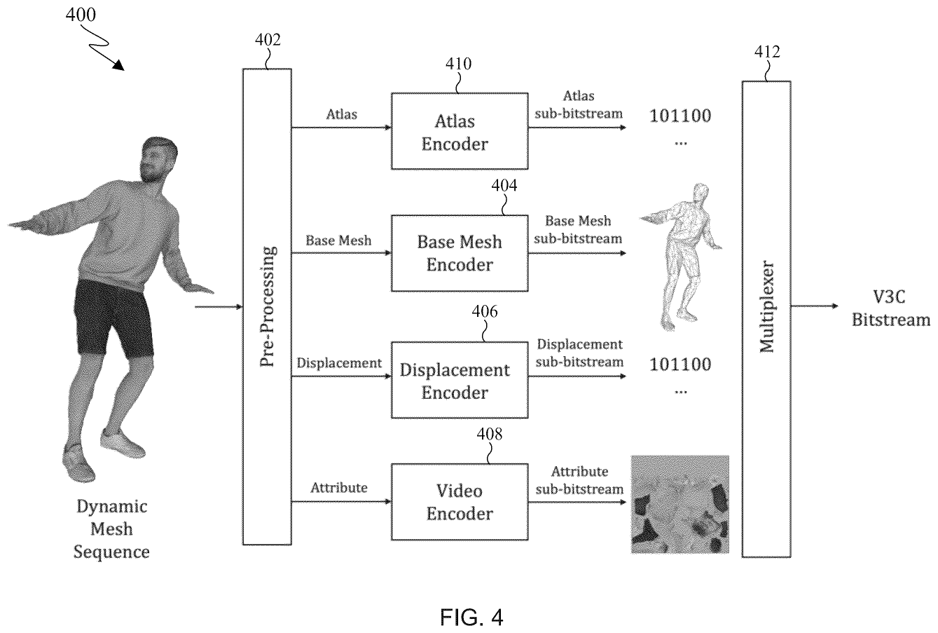

FIG. 4 illustrates an example encoding process 400 in accordance with this disclosure. The encoding process 400 illustrated in FIG. 4 is for illustration only. FIG. 4 does not limit the scope of this disclosure to any particular implementation of an encoding process. For ease of explanation, the process 400 of FIG. 4 may be described as being performed using the electronic device 300 of FIG. 3. However, the process 400 may be used with any other suitable system and any other suitable electronic device.

As shown in FIG. 4, the encoding process 400 performs pre-processing 402 on a dynamic mesh sequence using an encoder. The encoder can be represented by, or executed by, the server 200 shown in FIG. 2 or the electronic device 300 shown in FIG. 3. A base mesh, which typically has a smaller number of vertices compared to the original mesh, is created via the pre-processing 402. A base mesh encoder 404 is used to quantize and compress the base mesh in either a lossy or lossless manner, and the base mesh is encoded as a compressed base mesh sub-bitstream. The base-mesh can be intra coded (no prediction from neighboring base mesh frames) or inter coded (predicted from neighboring base-mesh frames).

The base mesh can then be reconstructed, providing a reconstructed base mesh. This reconstructed base mesh then undergoes one or more levels of subdivision and a displacement field is created by a displacement encoder 406 for each subdivision representing the difference between the original mesh and the subdivided reconstructed base mesh. In inter-coding of a mesh frame, the base mesh is coded by sending vertex motions instead of compressing the base mesh directly. In either case, a displacement field is created. Each displacement of the displacement field has three components, denoted by x, y, and z. These may be with respect to a canonical coordinate system or a local coordinate system where x, y, and z represent the displacement in local normal, tangent, and bi-tangent directions. It will be understood that multiple levels of subdivision can be applied, such that multiple subdivided mesh frames are created and a displacement field for each subdivided mesh frame is also created. As shown in FIG. 4, a displacement sub-bitstream is provided by the displacement encoder 406.

As also shown in FIG. 4, an attribute transfer operation can be performed using an video encoder 408. The video encoder 408 can use a deformed mesh, a static/dynamic mesh, and an attribute map to create an attribute sub-bitstream. The vertices of the mesh are a set of 3D points along with attributes such as color, normals, reflectivity, point-size, etc. that represent an object's surface or volume. These attributes are encoded as a compressed attribute bitstream. The encoding of the compressed attribute sub-bitstream may also include a padding operation, a color space conversion operation, and a video encoding operation. In various embodiments, an atlas can also be encoded as a compressed atlas sub-bitstream using an atlas encoder 410. The atlas component provides information to a decoding and/or rendering system on how to perform inverse reconstruction. For example, the atlas can provide information on how to perform the subdivision of a base mesh, how to apply the displacement vectors to the subdivided mesh vertices, and how to apply attributes to the reconstructed mesh.

Each of the sub-bitstreams are provided to a multiplexer 412. The multiplexer 412 multiplexes the sub-bitstreams and outputs a compressed bitstream (e.g., a V3C bitstream) that can, for example, be transmitted to, and decoded by, an electronic device such as the server 104 or the client devices 106-116. As shown in FIG. 4, the output compressed bitstream can include the compressed atlas bitstream, the compressed base mesh bitstream, the compressed displacements bitstream, and the compressed attribute bitstream as sub-bitstreams of the compressed bitstream.

Although FIG. 4 illustrates one example encoding process 400, various changes may be made to FIG. 4. For example, the number and placement of various components of the encoding process 400 can vary as needed or desired. In addition, the encoding process 400 may be used in any other suitable process and is not limited to the specific processes described above.

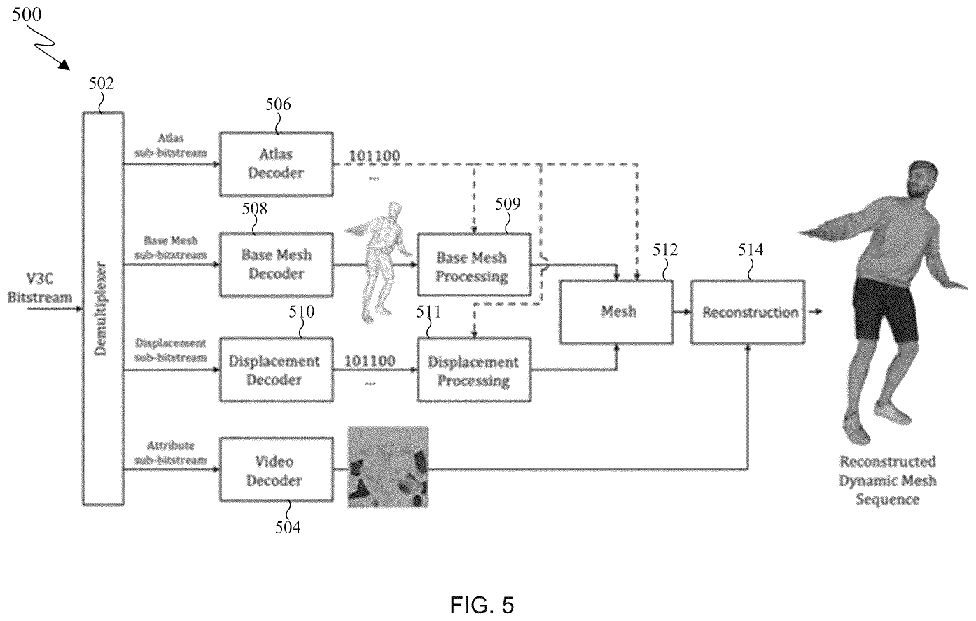

FIG. 5 illustrates an example mesh frame decoding process 500 in accordance with this disclosure. The decoding process 500 illustrated in FIG. 5 is for illustration only. FIG. 5 does not limit the scope of this disclosure to any particular implementation of a mesh frame decoding process. For ease of explanation, the process 500 of FIG. 5 may be described as being performed using the electronic device 300 of FIG. 3. However, the process 500 may be used with any other suitable system and any other suitable electronic device.

The decoding process 500 involves a demultiplexer 502 of a decoder that receives an incoming bitstream, e.g., the bitstream output by the encoder of the process 400 of FIG. 4. The demultiplexer 502 separates out the various component sub-bitstreams from the incoming bitstream, including the compressed base mesh sub-bitstream, the compressed displacement sub-bitstream, the compressed attribute sub-bitstream, and the atlas sub-bitstream, such as described with respect to FIG. 4. The compressed attribute sub-bitstream is decoded using a video decoder 504, the decoded attributes are processed using a color space conversion operation, and the original attributes for the mesh are recovered. The decoding process also can include processing the atlas sub-bitstream using an atlas decoder 506 to obtain the atlas data for the base mesh. The atlas sub-bitstream can be decoded to obtain an atlas that provides information on how to perform inverse reconstruction. For example, the atlas can provide information on how to perform the subdivision of a base mesh, how to apply the displacement vectors to the subdivided mesh vertices, and how to apply attributes to the reconstructed mesh.

The decoding process 500 also includes processing the base mesh sub-stream using a base mesh decoder 508. The base mesh decoder 508 decodes the base-mesh sub-bitstream to form a reconstructed base-mesh 512. A base mesh processing operation 509 is used with a displacement processing operation 511 to apply subdivision to the reconstructed base-mesh 512. Particularly, the decoding process 500 includes decoding the displacements sub-bitstream using a displacement decoder 510, which can, in some embodiments, be the same decoder as the video decoder 504. The decoded displacements data can undergo an image unpacking operation, an inverse quantization operation, and an inverse wavelet transform operation, as part of recovering the positions displacements data. Recovering the positions displacements data can also include performing using displacement processing operation 511 on the mesh frames recovered using a base mesh decoder 508, and extracting x, y, z components (normal, tangent, bitangent) from the subdivided mesh frames. The received displacement field is decompressed and added to the reconstructed base-mesh 512 as part of a reconstruction operation 514 to generate a final reconstructed mesh in the decoder, e.g., the reconstructed dynamic mesh sequence shown in FIG. 5.

Although FIG. 5 illustrates one example frame decoding process 500, various changes may be made to FIG. 5. For example, the number and placement of various components of the decoding process 500 can vary as needed or desired. In addition, the decoding process 500 may be used in any other suitable process and is not limited to the specific processes described above. Also, while shown as a series of steps, various steps in FIG. 5 may overlap, occur in parallel, or occur any number of times.

Various standards have been proposed with respect to vertex mesh and dynamic mesh coding. The following documents are hereby incorporated by reference in their entirety as if fully set forth herein:
“V-DMC TMM 8.0, ISO/IEC SC29 WG07 N00874,” June 2024;
“CD of V-DMC, ISO/IEC SC29 WG07 N00885,” June 2024; and
“Study of CD of V-DMC, ISO/IEC SC29 WG07 N00960,” August 2024.

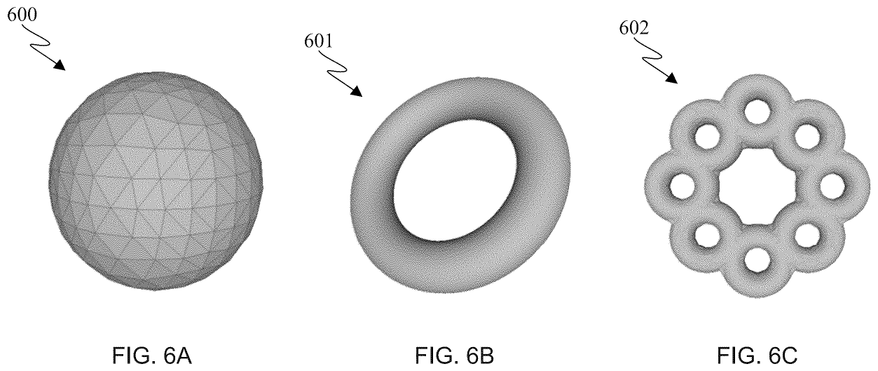

FIGS. 6A-6C illustrate example meshes 600, 601, and 602 in accordance with this disclosure. The example meshes 600, 601, and 602 illustrated in FIGS. 6A-6C, respectively, are for illustration only. FIGS. 6A-6C do not limit the scope of this disclosure to any particular type o of mesh. For ease of explanation, the example meshes 600, 601, and 602 of FIGS. 6A-6C may be described as being used by the electronic device 300 of FIG. 3 as part of mesh encoding/decoding, such as that described with respect to FIGS. 4 and 5. However, the example meshes 600, 601, and 602 may be used with any other suitable system and any other suitable electronic device.

The example mesh 600 of FIG. 6A has 0 handles, the example mesh 601 of FIG. 6B has 1 handle, and the example mesh 600 of FIG. 6A has 9 handles. When the triangles in these meshes are traversed, such as via an edge breaker algorithm, there is an ambiguity in the connectivity information and the two associated corner indices of the handle need to be transmitted to deal with this ambiguity. For example, in V-DMC, the syntax used for transmitting the handle information can be as shown in Table 1 below.

TABLE 1

| | |
|---|---|
| MinHandles = 10 | |
| mesh_handles_count | vu(v) |
| if( mesh_handles_count < MinHandles ) { | |
| for( i=0; i < mesh_handles_count; i++ ){ | |
| mesh_handle_first_delta[ i ] | vi(v) |
| mesh_handle_second_delta[ i ] | vi(v) |
| } | |
| } | |
| else { | |
| for( i=0; i< mesh_handles_count; i++ ){ | |
| mesh_handle_first_sign[ i ] | ae(v) |
| mesh_handle_second_shift[ i ] | ae(v) |
| mesh_handle_first_variable_delta_length4_minus1[ i ] | ae(v) |
| mesh_handle_first_variable_delta[ i ] | ae(v) |
| mesh_handle_second_variable_delta_length4_minus1[ i ] | ae(v) |
| mesh_handle_second_variable_delta[ i ] | ae(v) |
| } | |
| } | |

The syntax elements shown in Table 1 are as follows. mesh_handles_count[i] specifies the number of handles comprised in the i-th connected component with non zero handle count. mesh_handle_first_delta[i] specifies the difference between the i-th handle first corner and the (i−1)-th handle first corner when i is greater than 0. When i is equal to 0 mesh_handle_index_first_delta[0] specifies the first handle first corner. mesh_handle_second_delta[i] specifies the difference between the i-th handle second corner and the (i−1)-th handle second corner when i is greater than 0.

When i is equal to 0 mesh_handle_index_second_delta[0] specifies the first handle second corner. mesh_handle_first_sign[i] specifies if the handle is associated with a boundary or not. When mesh_handle_first_sign[i] is equal to 0, the corner index associated with the i-th handle first corner will be smaller than zero, indicating that the handle is associated with a boundary. When mesh_handle_first_sign[i] is equal to 1, the corner index associated with the i-th handle first corner will be greater than zero, indicating that the handle is not associated with a boundary mesh_handle_second_shift[i] specifies the shift to apply when computing the corner index associated with the i-th handle second corner.

Note that handle indices are relative to a triangle/face, index as related corner indices can be deduced implicitly. The corner index of the first handle is conforming to either (3*T+2) or (−3*T−2). The corner index of the second handle f index is conforming to either (3*T+1) or (3*T+2). mesh_handle_first_sign[i] and mesh_handle_index_second_shift[i] are used to discriminate those cases.

Further, mesh_handle_first_variable_delta_length4_minus1[i] specifies the number of groups of four bits used to represent mesh_handle_first_variable_delta[i]. mesh_handle_first_variable_delta[i] specifies an intermediate value used to evaluate the corner index associated with the i-th handle first corner.

The number of bits used to represent mesh_handle_first_variable_delta[i] is equal to (4*(mesh_handle_index_first_variable_delta_length4_minus1+1)).

mesh_handle_index_second_variable_delta_length4_minus1[i] specifies the number of groups of four bits used to represent mesh_handle_second_variable_delta[i]. mesh_handle_second_variable_delta[i] specifies an intermediate value used to evaluate the corner index associated with the i-th handle second corner.

The number of bits used to represent mesh_handle_second_variable_delta[i] is equal to (4*(mesh_handle_index_second_variable_delta_length4_minus1+1)).

For example, let a 2D array HandlesArray, of size mesh_handles_count×2, specifying for each handle two associated corner indices, be derived as follows:

Let the variables handleFirst, handleSecond, firstSign and secondSign be initialized to 0.

If mesh_handles_count is less than MinHandles, the following applies:

```
for( i = 0; i< mesh_handles_count; i++ ) {
  handleFirst += mesh_handle_first_delta[ i ]
  handleSecond += mesh_handle_second_delta[ i ]
  HandlesArray[ i ][ 0 ] = handleFirst
  HandlesArray[ i ][ 1 ] = handleSecond
}
```

Else, if mesh_handles_count is greater than or equal to MinHandles, the following applies:

```
for( i = 0; i< mesh_handles_count; i++ ){
  firstSign = 1 − 2 * ( mesh_handle_first_variable_delta[ i ] & 1)
  handleFirst += firstSign * mesh_handle_first_variable_delta[ i ] + 1 ) / 2
  secondSign = 1 − 2 * ( mesh_handle_second_variable_delta[ i ] & 1)
  handleSecond += secondSign * mesh_handle_second_variable_delta[ i ] + 1 ) / 2
  HandlesArray[ i ][ 0 ] =
    ( 3 * handleFirst + 2 ) * (2 * mesh_handle_first_sign[ i ] − 1)
  HandlesArray[ i ][ 1 ] =
    ( 3 * handleSecond + 1 ) + mesh_handle_second_shift[ i ]
}
```

A combination of variable length coding (non-arithmetic coding, mesh_handles_count<MinHandles) and arithmetic coding (mesh_handles_count>=MinHandles) is used for coding the handle information.

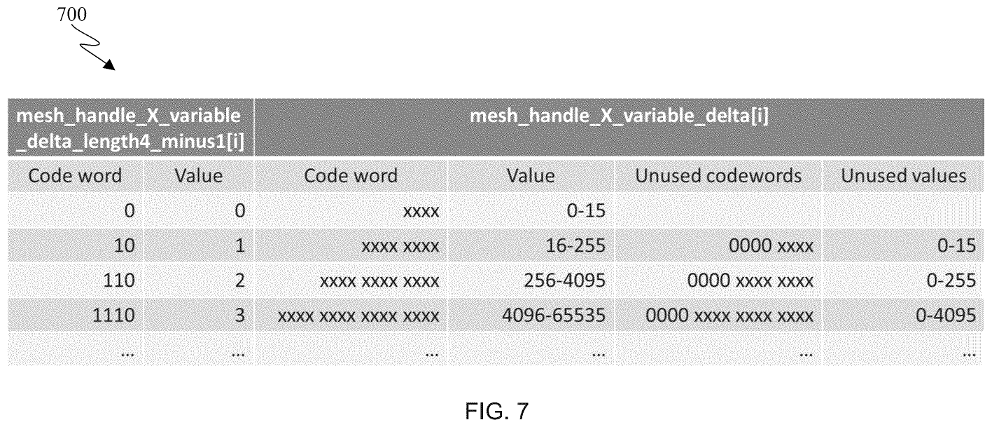

FIG. 7 illustrates example binarization coding information 700. When arithmetic coding is used, mesh_handle_first_variable_delta and mesh_handle_second_variable_delta are coded using the binarization shown in FIG. 7.

mesh_handle_first_variable_delta_length4_minus1 and mesh_handle_second_variable_delta_length4_minus1 syntax elements (indicated as “mesh_handle_X_variable_delta_length4_minus1” in FIG. 7) are binarized using truncated unary code, whereas mesh_handle_first_variable_delta and mesh_handle_second_variable_delta syntax elements (indicated as “mesh_handle_X_variable_delta” in FIG. 7) are coded using a fixed length binarization. The number of bins used for mesh_handle_X_variable_delta is 4*(mesh_handle_X_variable_delta_length4_minus1+1).

As shown in FIG. 7, ‘x’ indicates either a 0 or 1. The “ . . . ” shown in the last row of FIG. 7 indicates that there are more code words that follow the same logic of FIG. 7, and as defined in the V-DMC specification. However, it can be noticed from FIG. 7 that there are some unused codewords leading to loss in compression efficiency. The present disclosure seeks to alleviate and improve upon these inefficiencies.

For example, this disclosure provides, in some embodiments, for using only arithmetic coding for coding the mesh handle information. This is like setting MinHandles to 0 to trigger use of arithmetic coding, eliminating the need to check the mesh handles count as in existing implementations. For illustrative purposes, the corresponding modifications to the syntax elements are shown in Table 2 below. Syntax elements that are no longer needed with respect to the checking of the minimum handles count are shown as deletions via bolded brackets: [ ].

TABLE 2

| | |
|---|---|
| mesh_handles_count | vu(v) |
| [MinHandles = 10] | |
| [if( mesh_handles_count < MinHandles ) {] | |
| [for( i=0; i < mesh_handles_count; i++ ){] | |
| [mesh_handle_first_delta[ i ]] | [vi(v)] |
| mesh_handle_second_delta[ i ]] | [vi(v)] |
| [}] | |
| [padding_to_byte_alignment( )] | |
| [}] | |
| if( mesh_entropy_packets_enable_flag ) { | |
| mesh_position_packet_size | vu(v) |
| EntropyPacketPtr = read_bytes( mesh_position_packet_size ) | |
| } else { | |
| mesh_all_packet_size | vu(v) |
| EntropyPacketPtr = read_bytes( mesh_all_packet_size ) | |
| } | |
| [if ( mesh_handles_count >= MinHandles ) {] | |
| for( i=0; i< mesh_handles_count; i++ ){ | |
| mesh_handle_first_sign[ i ], EntropyPacketPtr | ae(v) |
| mesh_handle_second_shift[ i ], EntropyPacketPtr | ae(v) |
| mesh_handle_first_variable_delta_length4_minus1[ i ], EntropyPacketPtr | ae(v) |
| mesh_handle_first_variable_delta[ i ], EntropyPacketPtr | ae(v) |
| mesh_handle_second_variable_delta_length4_minus1[ i ], EntropyPacketPtr | ae(v) |
| mesh_handle_second_variable_delta[ i ], EntropyPacketPtr | ae(v) |
| } | |
| } | |

As shown above in Table 2, this disclosure discards with checking the handles count against a minimum to determine if variable length (non-arithmetic) coding or arithmetic coding is to be used, and instead uses just arithmetic coding. This alone (using just arithmetic coding to code the handle information) has been found to provide for bitrate savings in the coding of the base-mesh, such as savings of −0.04%. The gain is observed in sequences that have handle information.

Additionally, it can be seen in FIG. 7 that there are some unused codewords, which leads to losses in compression efficiency. This disclosure thus also provides for modifying the coded values such that there are no unused codewords.

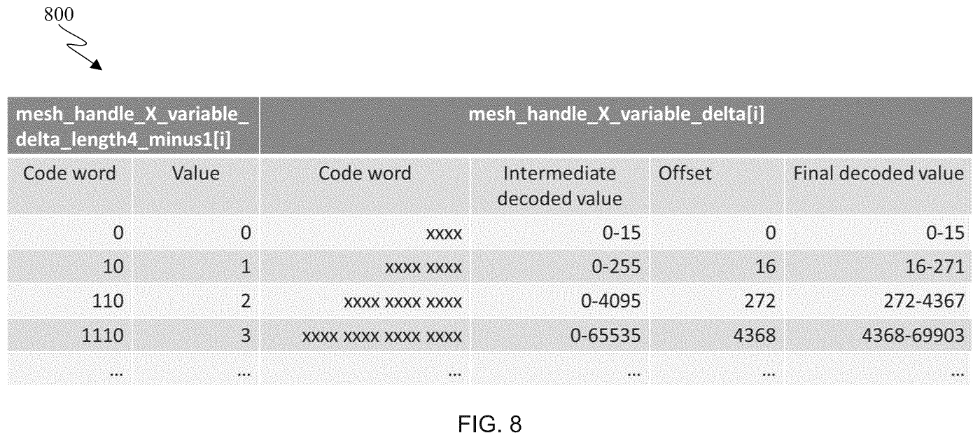

For example, FIG. 8 illustrates example binarization coding information 800 in accordance with this disclosure. The binarization coding information 800 illustrated in FIG. 8 is for illustration only. FIG. 8 does not limit the scope of this disclosure to any particular binarization coding information or to any particular way of portraying such information. For ease of explanation, the binarization coding information 800 of FIG. 8 may be described as being used by the electronic device 300 of FIG. 3, such as during encoding/decoding operations. However, the binarization coding information 800 may be used with any other suitable system and any other suitable electronic device.

As shown in FIG. 8, this disclosure provides for adding an offset to the fixed length decoded value to generate the final decoded value and avoid unused code words. The use of the offset in obtaining the final decoded value is detailed further below. In some embodiments, to further increase the coding efficiency, the number of bits in each code word group is reduced while implementing an offset in determining the final decoded value. For example, in various embodiments, the syntax element of mesh_handle_X_variable_delta_length4_minus1 is changed to mesh_handle_X_variable_delta_length3_minus1.

When N=3, the following syntax elements shown in Table 3 can be used.

TABLE 3

| | |
|---|---|
| for( i=0; i< mesh_handles_count; i++ ) { | |
| mesh_handle_first_sign[ i ], EntropyPacketPtr | ae(v) |
| mesh_handle_second_shift[ i ], EntropyPacketPtr | ae(v) |
| mesh_handle_first_variable_delta_length3_minus1[ i ], EntropyPacketPtr | ae(v) |
| mesh_handle_first_variable_delta[ i ], EntropyPacketPtr | ae(v) |
| mesh_handle_second_variable_delta_length3_minus1[ i ], EntropyPacketPtr | ae(v) |
| mesh_handle_second_variable_delta[ i ], EntropyPacketPtr | ae(v) |
| } | |
| } | |

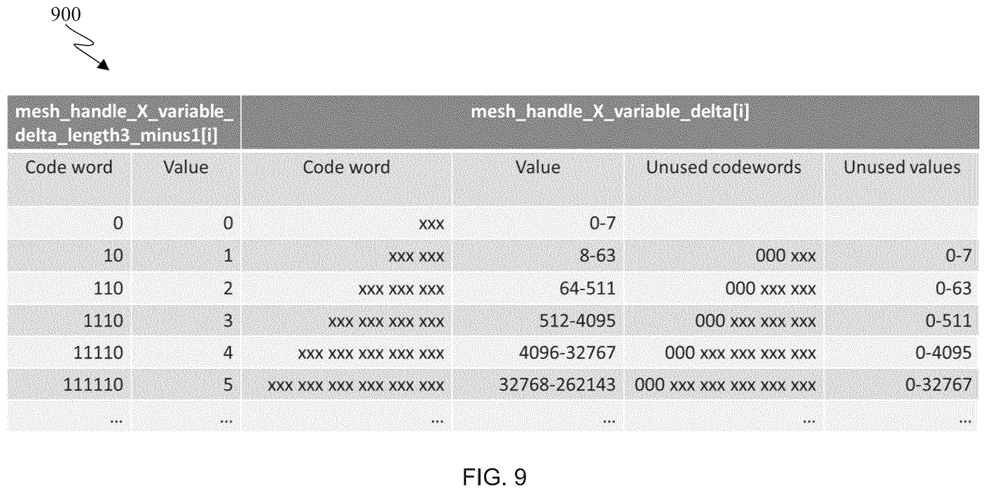

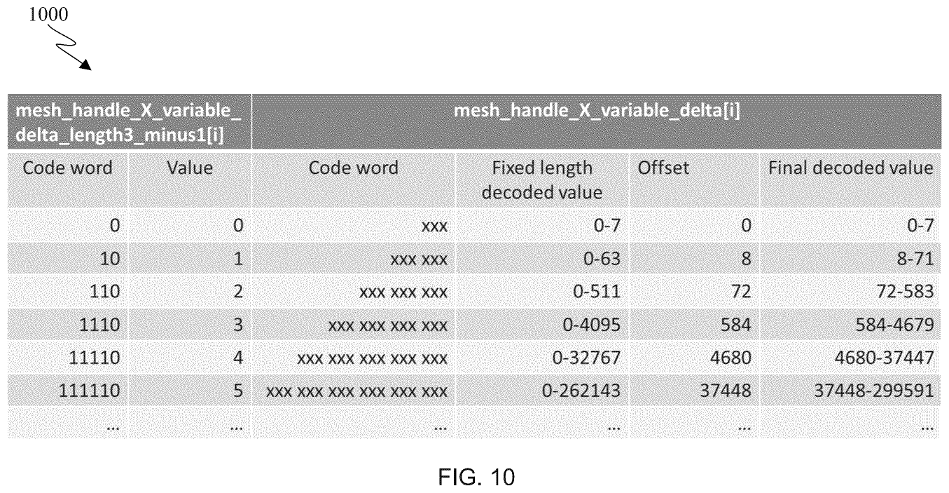

Thus, mesh_handle_first_variable_delta_length3_minus1 [i] specifies the number of groups of three bits used to represent mesh_handle_first_variable_delta[i]. mesh_handle_second_variable_delta_length3_minus1 [i] specifies the number of groups of three bits used to represent mesh_handle_first_variable_delta[i]. This is shown in FIGS. 9 and 10.

FIG. 9 illustrates example binarization coding information 900 where groups of 3 bits are used to represent the mesh handle information, but no offset is used, leading again to unused codewords. FIG. 9 shows the corresponding binarization. The number of bins used for mesh_handle_X_variable_delta is 3*(mesh_handle_X_variable_delta_length3_minus1+1).

FIG. 10 illustrates example binarization coding information 1000 using groups of 3 bits, and also using an offset, in accordance with this disclosure. The binarization coding information 1000 illustrated in FIG. 10 is for illustration only. FIG. 10 does not limit the scope of this disclosure to any particular binarization coding information or to any particular way of portraying such information. For ease of explanation, the binarization coding information 1000 of FIG. 10 may be described as being used by the electronic device 300 of FIG. 3, such as during encoding/decoding operations. However, the binarization coding information 1000 may be used with any other suitable system and any other suitable electronic device.

As mentioned, it can be seen from FIGS. 7 and 9 that unused codewords lead to loss in compression efficiency. In embodiments of this disclosure, as shown in FIGS. 8 and 10, the values coded are modified such that there are no unused codewords. An offset is added to the fixed length decoded value to generate the final decoded value and avoid unused code words. FIGS. 8 and 10 demonstrate that offsets can be used for different numbers of bits, e.g., 4 or 3 in these examples.

As shown in FIGS. 8 and 10, the offsets are applied to fixed length decoded values to obtain a final decoded value. For example, in various embodiments, let N be equal to the number of bits grouped to generate mesh_handle_first_variable_delta and mesh_handle_second_variable_delta (indicated as mesh_handle_X_variable_delta). Let mesh_handle_X_variable_delta_lengthN_minus1 specifies the number of groups of N bits used to represent mesh_handle_X_variable_delta[i].

In the encoder, the following pseudo-code illustrates how to generate the mesh_handle_X_variable_delta_lengthN_minus1 and mesh_handle_X_variable_delta values. HND_DELTA_LENGTH_N_MAX is the maximum possible value of mesh_handle_X_variable_delta_lengthN_minus1.

```
for (auto i = 1; i < HND_DELTA_LENGTH_N_MAX; ++i) {
  if (val < HND_OFFSET[i]) {
    nb = i;
    val = val − HND_OFFSET[i − 1];
    break;
  }
}
mesh_handle_X_variable_delta_lengthN_minus1 = nb
mesh_handle_X_variable_delta = val
```

HND_OFFSET[0]=0, HND_OFFSET[i] for other values if “i” is given by:

$$HND\_OFFSET [ i ] = {\sum }_{n = 1}^{i} {2}^{N n}$$

In the decoder, the decoder obtains the final decoded value by adding the offset to the fixed length decoded value. For instance, in the decoder, let nb be the decoded value of mesh_handle_X_variable_delta_lengthN_minus1. Let val be set to the fixed length decoded value of mesh_handle_X_variable_delta. The final value of mesh_handle_X_variable_delta is calculated by adding an offset as follows:

$$val = val + HND\_OFFSET [ n b - 1 ]$$

In this way, there are no unused codewords, increasing coding efficiency. This if further illustrated by the following. In various embodiments, the following pseudo-code is used to convert the syntax elements mesh_handle_first_variable_delta[i], mesh_handle_second_variable_delta[i], mesh_handle_first_variable_delta_length3_minus1 [i], mesh_handle_second_variable_delta_length3_minus1 [i] into handle information (HandlesArray[ ][ ]). Let a 2D array HandlesArray, of size mesh_handles_count×2, specifying for each handle two associated corner indices, be derived as follows:

Let the variables handleFirst, handleSecond, firstSign and secondSign be initialized to 0

```
offset[10] = [0, 8, 72, 584, 4680, 37448, 299592, 2396744, 19173960, 153391688]
  for( i = 0; i< mesh_handles_count; i++ ){
  mesh_handle_first_variable_delta[ i ] +=
    offset[ mesh_handle_first_variable_delta_length3_minus1[ j ] ]
  mesh_handle_second_variable_delta[ i ] +=
    offset[ mesh_handle_second_variable_delta_length3_minus1[ j ] ]
  firstSign = 1 − 2 * ( mesh_handle_first_variable_delta[ i ] & 1)
  handleFirst += firstSign * mesh_handle_first_variable_delta[ i ] + 1 ) / 2
  secondSign = 1 − 2 * ( mesh_handle_second_variable_delta[ i ] & 1)
  handleSecond += secondSign * mesh_handle_second_variable_delta[ i ] + 1 ) / 2
  HandlesArray[ i ][ 0 ] =
    ( 3 * handleFirst + 2 ) * (2 * mesh_handle_first_sign[ i ] − 1 )
  Handles Array[ i ][ 1 ] =
    ( 3 * handleSecond + 1 ) + mesh_handle_second_shift[ i ]
```

In some embodiments, Table 4 below showing MPEG EdgeBreaker syntax element specific parsing processes (ae(v)) includes modified syntax elements for mesh_handle_first_variable_delta_length3_minus1[i] and mesh_handle_first_variable_delta_length3_minus1[i], where these syntax elements are binarized with a truncated unary code with maxVal=10 as specified. mesh_handle_first_variable_delta[i] is binarized as a fixed length code with a length of 3*(mesh_handle_first_variable_delta_length3_minus1 [i]+1). mesh_handle_second_variable_delta[i] is binarized as a fixed length code with a length of 3*(mesh_handle_second_variable_delta_length3_minus1[i]+1).

| Syntax element | Parsing | Parameters |
|---|---|---|
| mesh_position_fine_residual[ ][ ] | K.2.5 (TU + EGk + S) | maxOffset = 7, k = 2 |
| mesh_position_coarse_residual[ ][ ] | K.2.5 (TU + EGk + S) | maxOffset = 7, k = 2 |
| mesh_attribute_fine_residual[ ][ ][ ] | /* TEXCOORD */ | /* TEXCOORD */ |
| | K.2.5 (TU + EGk + S) | maxOffset = 7, k = 2 |
| | /* NORMAL */ | /* NORMAL */ |
| | K.2.5 (TU + EGk + S) | maxOffset = 7, k = 5 |
| | /* GENERIC*/ | /* GENERIC*/ |
| | K.2.5 (TU + EGk + S) | maxOffset = 7, k = 2 |
| | /* MATERIAL_ID */ | /* MATERIAL_ID */ |
| | K.2.3 (EGk) | k = 2 |
| mesh_attribute_coarse_residual[ ][ ][ ] | /* TEXCOORD */ | /* TEXCOORD */ |
| | K.2.5 (TU + EGk + S) | maxOffset = 7, k = 2 |
| | /* NORMAL */ | /* NORMAL */ |
| | K.2.5 (TU + EGk + S) | maxOffset = 7, k = 5 |
| | /* GENERIC */ | /* GENERIC*/ |
| | K.2.5 (TU + EGk + S) | maxOffset = 7, k = 2 |
| mesh_normal_octahedral_second_residual[ ][ ][ ] | K.2.5 (TU + EGk + S) | maxOffset = 7, k = 1 |
| mesh_clers_symbol[ ] | K.2.7 | |
| mesh_attribute_seam[ ][ ] | K.2.1 (FL) | numBins = 1 |
| mesh_texcoord_stretch_orientation[ ][ ] | K.2.1 (FL) | numBins = 1 |
| mesh_handle_first_sign[ ] | K.2.1 (FL) | numBins = 1 |
| mesh_handle_second_shift[ ] | K.2.1 (FL) | numBins = 1 |
| mesh_handle_first_variable_delta_length3_minus1[i] | K.2.6 (TU) | maxVal = 10 |
| mesh_handle_first_variable_delta[i] | K.2.1 (FL) | numBins = 3*(D1L + 1) |
| mesh_handle_second_variable_delta_length3_minus1[i] | K.2.6 (TU) | maxVal = 10 |
| mesh_handle_second_variable_delta[i] | K.2.1 (FL) | numBins = 3*(D2L + 1) |
| mesh_position_is_duplicate_flag[ ] | K.2.1 (FL) | numBins = 1 |
| mesh_attribute_is_duplicate_flag[ ][ ] | K.2.1 (FL) | numBins = 1 |
| mesh_materialid_default_not_equal_flag[ ][ ] | K.2.1 (FL) | numBins = 1 |
| mesh_materialid_default_left_flag[ ][ ] | K.2.1 (FL) | numBins = 1 |
| mesh_materialid_default_right_flag[ ][ ] | K.2.1 (FL) | numBins = 1 |
| mesh_materialid_default_facing_flag[ ][ ] | K.2.1 (FL) | numBins = 1 |

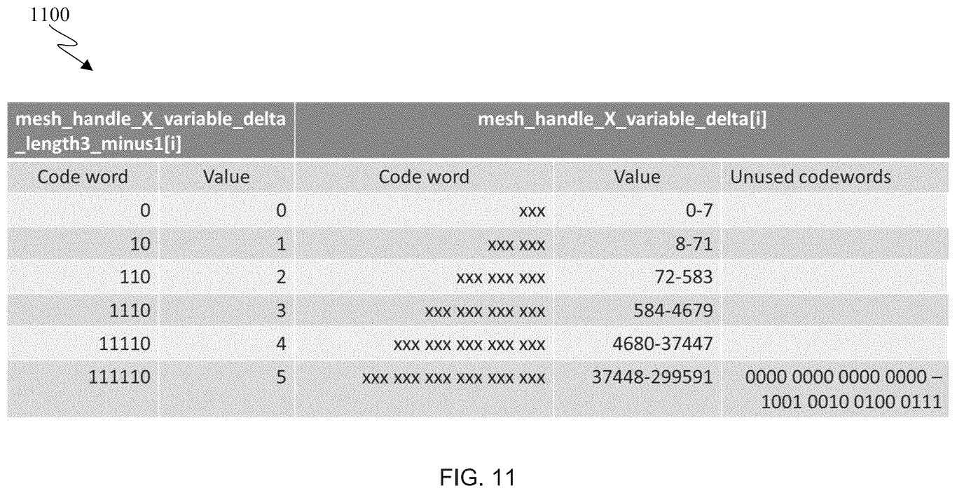

In some embodiments, when N=3, depending on the value of HND_DELTA_LENGTH_3_MAX, the number of iterations in the encoder may be large. Thus, in various embodiments of this disclosure, a mix of the use of fixed length coding and arithmetic coding using offsets can be performed to limit the maximum number of iterations. For example, FIG. 11 shows the corresponding binarization.

FIG. 11 illustrates example binarization coding information 1100 using a maximum number of offsets, in accordance with this disclosure. The binarization coding information 1100 illustrated in FIG. 11 is for illustration only. FIG. 11 does not limit the scope of this disclosure to any particular binarization coding information or to any particular way of portraying such information. For ease of explanation, the binarization coding information 1100 of FIG. 11 may be described as being used by the electronic device 300 of FIG. 3, such as during encoding/decoding operations. However, the binarization coding information 1100 may be used with any other suitable system and any other suitable electronic device.

In the example of FIG. 11, the maximum number of offsets is set to five, although it will be understood that the maximum offset can be set to other values. As shown in FIG. 11, offsets are used for the first five value rows of the binarization coding information 1100. Once the sixth row is reached, and the codewords thus include 6 groups of 3-bits, no offset is used and direct fixed length coding is used. Although, as shown in FIG. 11, this results in some unused codewords, this still allows for previous coding to avoid unused codewords, while also decreasing the number of iterations to process the data, leading to an overall improvement in coding and transmission efficiency.

In various embodiments such as in FIG. 11 where a mix of the use of fixed length coding and arithmetic coding is used, the following pseudo-code is used in the encoder to generate the values of mesh_handle_X_variable_delta_length3_minus1 and mesh_handle_X_variable_delta:

```
#define HND_PREFIX_K 3
const int HND_MAX_NUM_OFFSET = 6;
  if (val < HND_OFFSET[HND_MAX_NUM_OFFSET − 1]) {
    for (auto i = 1; i < HND_MAX_NUM_OFFSET; ++i) {
      if (val < HND_OFFSET[i]) {
        nb = i;
        val = val − HND_OFFSET[i − 1];
        break;
      }
    }
  }
  else {
    nb = std::ceil(log2(val + 1) / HND_PREFIX_K);
  }
  mesh_handle_X_variable_delta_length3_minus1 = nb
  mesh_handle_X_variable_delta = val
```

In various embodiments, in the decoder, let nb be the decoded value of mesh_handle_X_variable_delta_length3_minus1. Let val be set to the fixed length decoded value of mesh_handle_X_variable_delta. The final value of mesh_handle_X_variable_delta is calculated by adding an offset when (nb<HND_MAX_NUM_OFFSET). If (nb>=HND_MAX_NUM_OFFSET), then no offset is added. This can be represented by the following pseudo-code:

```
if(nb < HND_MAX_NUM_OFFSET)
    val = val + HND_OFFSET[nb − 1]
  mesh_handle_X_variable_delta = val
```

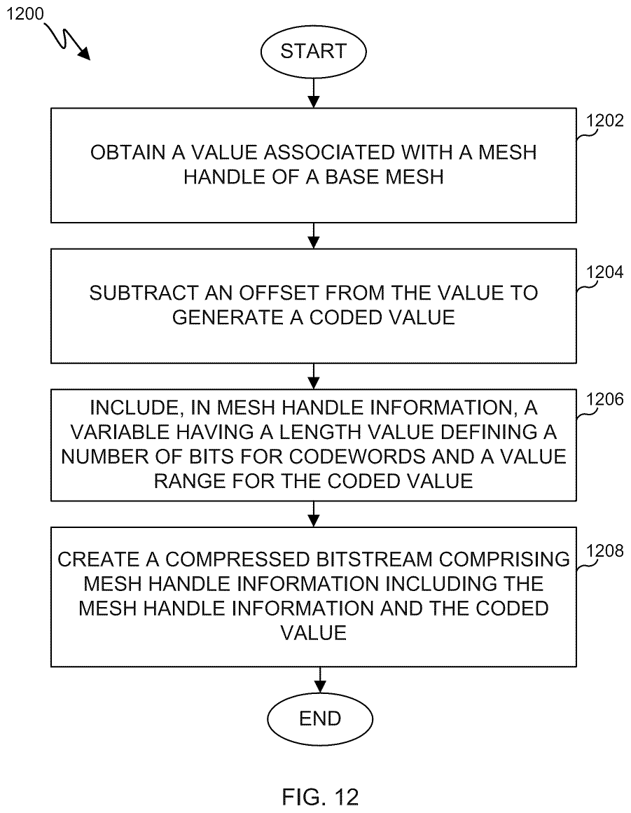

FIG. 12 illustrates an example encoding method 1200 in accordance with this disclosure. For ease of explanation, the method 1200 of FIG. 12 is described as being performed using the electronic device 300 of FIG. 3. However, the method 1200 may be used with any other suitable system and any other suitable electronic device.

As shown in FIG. 12, at step 1202, and as also described with respect to FIGS. 4-11, the electronic device 300 obtains a value associated with a mesh handle of a base mesh. At step 1204, the electronic device 300 subtracts an offset from the value to generate a coded value. The coded value is created for inclusion in a compressed bitstream.

As described in this disclosure, at step 1206, the electronic device 300 can also, as part of creating the compressed bitstream, include in the mesh handle information a variable having a length value defining a number of bits for codewords and a value range for the coded value. In some embodiments, the number of bits is a multiple of three. In some embodiments, as described in this disclosure, the variable further specifies a number of groups of N bits used to represent a mesh handle variable delta. In some embodiments, as described in this disclosure, the electronic device 300 can also generate a plurality of coded values using a plurality of offsets. In some embodiments, as described in this disclosure, a limit is imposed on a determined number of the plurality of offsets to prevent processing of iterations beyond the determined number.

At step 1208, the electronic device 300 creates the compressed bitstream including the mesh handle information and the coded value. As described in this disclosure, the compressed bitstream can be multiplexed to include sub-bitstreams such as an atlas sub-bitstream, a base-mesh sub-bitstream, a displacement sub-bitstream, and an attribute sub-bitstream. In some embodiments, as described in this disclosure, only arithmetic coding is utilized to code the mesh handle information, where a minimum amount of handles is set to zero. The output compressed bitstream can be transmitted to an external device or to a storage on the electronic device 300.

Although FIG. 12 illustrates one example of an encoding method 1200, various changes may be made to FIG. 12. For example, while shown as a series of steps, various steps in FIG. 12 may overlap, occur in parallel, or occur any number of times. It will be understood that the method 1200 can be used with any number of coded values and any number of offsets, and the method 1200 as described is merely for illustrative purposes.

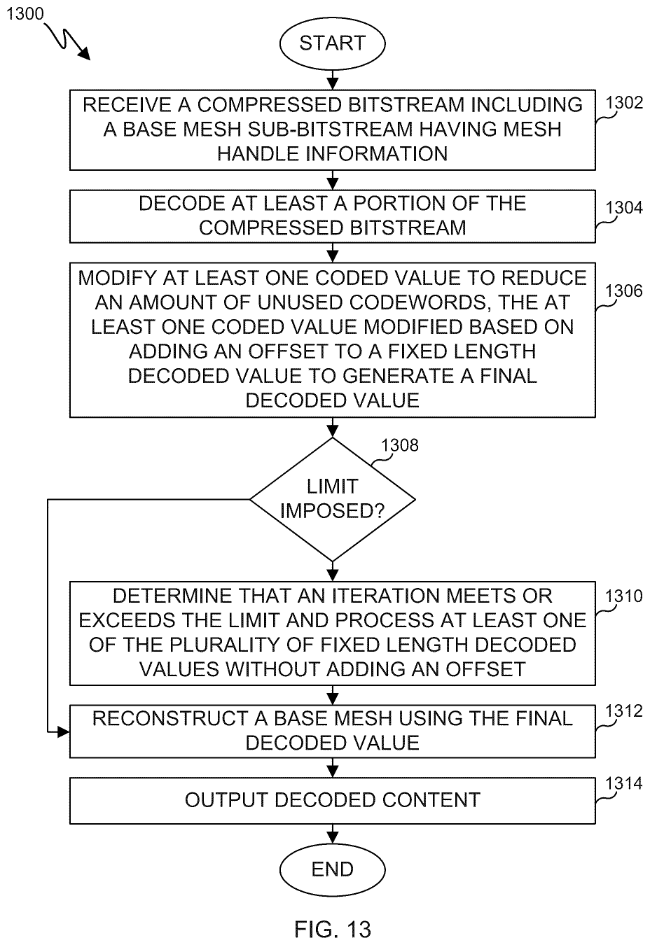

FIG. 13 illustrates an example decoding method 1300 in accordance with this disclosure. For ease of explanation, the method 1300 of FIG. 13 is described as being performed using the electronic device 300 of FIG. 3. However, the method 1300 may be used with any other suitable system and any other suitable electronic device.

As shown in FIG. 13, at step 1302, the electronic device 300 receives a compressed bitstream including a base mesh sub-bitstream, the base mesh sub-bitstream including mesh handle information. In some embodiments, as described in this disclosure, only arithmetic coding is utilized to code the mesh handle information, wherein a minimum amount of handles is set to zero. At step 1304, the electronic device 300 decodes at least a portion of the compressed bitstream. At step 1306, the electronic device 300 modifies at least one coded value from the decoded portion of the compressed bitstream. The at least one coded value is modified based on adding an offset to a fixed length decoded value to generate a final decoded value. As described in this disclosure, this modification reduces an amount of unused codewords.

In some embodiments, as described in this disclosure, the mesh handle information in the base mesh sub-bitstream can include a variable having a length value defining a number of bits for codewords and a value range for the fixed length decoded value used to generate the final decoded value. In some embodiments, as described in this disclosure, the number of bits is a multiple of three. In some embodiments, as described in this disclosure, the variable further specifies a number of groups of N bits used to represent a mesh handle variable delta.

At step 1308, it is determined whether a limit on the number of offsets is imposed. For example, in some embodiments, as described in this disclosure, the electronic device 300 can generate a plurality of final decoded values using a plurality of fixed length decoded values by adding one of a plurality of offsets to one of the plurality of fixed length decoded values. A limit can be imposed on a determined number of the plurality of offsets to prevent processing of iterations beyond the determined number.

If, at step 1308, it is determined that no limit is imposed on the number of offsets, the method 1300 moves to step 1312. If, however, at step 1308, it is determined that a limit is imposed on the number of offsets, the method 1300 moves to step 1310. At step 1310, the electronic device 300 determines that an iteration meets or exceeds the limit and processes at least one of the plurality of fixed length decoded values without adding an offset. The method 1300 then moves to step 1312.

At step 1312, the electronic device 300 reconstructs a base mesh using the final decoded value. At step 1314, the electronic device 300 outputs decoded content using the reconstructed base mesh, such as 3D video including a reconstructed mesh-frame. The output decoded content can be transmitted to an external device or to a storage on the electronic device 300, for instance.

Although FIG. 13 illustrates one example of a decoding method 1300, various changes may be made to FIG. 13. For example, while shown as a series of steps, various steps in FIG. 13 may overlap, occur in parallel, or occur any number of times. It will be understood that the method 1300 can be used with any number of coded values and any number of offsets, and the method 1300 as described is merely for illustrative purposes.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. An apparatus comprising:
a communication interface configured to receive a compressed bitstream comprising a base mesh sub-bitstream including mesh handle information; and
a processor operably coupled to the communication interface, wherein the processor is configured to:
decode at least a portion of the compressed bitstream;
modify at least one coded value to reduce an amount of unused codewords, wherein the at least one coded value is modified based on adding an offset to a fixed length decoded value to generate a final decoded value; and
reconstruct a base mesh using the final decoded value.

2. The apparatus of claim 1, wherein the mesh handle information includes a variable having a length value defining a number of bits for codewords and a value range for the fixed length decoded value used to generate the final decoded value.

3. The apparatus of claim 2, wherein the number of bits is a multiple of three.

4. The apparatus of claim 2, wherein the variable further specifies a number of groups of N bits used to represent a mesh handle variable delta.

5. The apparatus of claim 1, wherein only arithmetic coding is utilized to code the mesh handle information, wherein a minimum amount of handles is set to zero.

6. The apparatus of claim 1, wherein the processor is further configured to generate a plurality of final decoded values using a plurality of fixed length decoded values by adding one of a plurality of offsets to one of the plurality of fixed length decoded values.

7. The apparatus of claim 6, wherein a limit is imposed on a determined number of the plurality of offsets to prevent processing of iterations beyond the determined number.

8. The apparatus of claim 7, wherein the processor is further configured to:
determine that an iteration meets or exceeds the limit; and
process at least one of the plurality of fixed length decoded values without adding an offset.

9. A method comprising:
receiving a compressed bitstream comprising a base mesh sub-bitstream including mesh handle information; and
modifying at least one coded value to reduce an amount of unused codewords, wherein the at least one coded value is modified based on adding an offset to a fixed length decoded value to generate a final decoded value; and
reconstructing a base mesh using the final decoded value.

10. The method of claim 9, wherein the mesh handle information includes a variable having a length value defining a number of bits for codewords and a value range for the fixed length decoded value used to generate the final decoded value.

11. The method of claim 10, wherein the number of bits is a multiple of three.

12. The method of claim 10, wherein the variable further specifies a number of groups of N bits used to represent a mesh handle variable delta.

13. The method of claim 9, wherein only arithmetic coding is utilized to code the mesh handle information, wherein a minimum amount of handles is set to zero.

14. The method of claim 9, further comprising generating a plurality of final decoded values using a plurality of fixed length decoded values by adding one of a plurality of offsets to one of the plurality of fixed length decoded values.

15. The method of claim 14, wherein a limit is imposed on a determined number of the plurality of offsets to prevent processing of iterations beyond the determined number.

16. The method of claim 15, further comprising:
determining that an iteration meets or exceeds the limit; and
processing at least one of the plurality of fixed length decoded values without adding an offset.

17. An apparatus comprising:
a communication interface; and
a processor operably coupled to the communication interface, the processor configured to:
obtain a value associated with a mesh handle of a base mesh;
subtract an offset from the value to generate a coded value; and
create a compressed bitstream comprising mesh handle information including the coded value.

18. The apparatus of claim 17, wherein, to create the compressed bitstream, the processor is further configured to include, in the mesh handle information, a variable having a length value defining a number of bits for codewords and a value range for the coded value in the compressed bitstream.

19. The apparatus of claim 18, wherein the number of bits is a multiple of three.

20. The apparatus of claim 17, wherein the processor is further configured to generate a plurality of coded values using a plurality of offsets, and wherein a limit is imposed on a determined number of the plurality of offsets to prevent processing of iterations beyond the determined number.
